(19) United States
(12) Patent Application Publication
(10) Pub. No.: US 2019/0114574 A1
(43) Pub. Date: Apr. 18, 2019

(54) MACHINE-LEARNING MODEL TRAINED ON EMPLOYEE WORKFLOW AND SCHEDULING DATA TO RECOGNIZE PATTERNS ASSOCIATED WITH EMPLOYEE RISK FACTORS

(71) Applicant: API HEALTHCARE CORPORATION, SEATTLE, WA (US)

(72) Inventor: Kenzie Greenawalt, Madison, WI (US)

(21) Appl. No.: 15/786,562

(22) Filed: Oct. 17, 2017

(51) Int. Cl. G06Q 10/06; G06N 3/08; G06F 15/18

(52) U.S. Cl. CPC G06Q 10/063112; G06Q 10/063114; G06Q 10/0635; G06F 15/18; G06Q 10/06398; G06N 3/084; G06Q 10/0633

(57) ABSTRACT

A system that facilitates employee scheduling is provided herein. The system can comprise a processor, a machine-learning model, and a scheduling component. The processor can execute computer-implemented components stored in memory. The machine learning is model trained on employee workflow and scheduling data to determine and/or infer one or more employee risk factors (ERFs) that are parameters affecting an employee schedule. The machine-learning model can recognize patterns associated with the ERFs. The scheduling component schedules respective employees based on respective ERFs associated with those employees.

### TECHNICAL FIELD

The subject disclosure relates generally to scheduling objects based on risk factors with characteristics shared between at least some of the objects that can affect optimizing a new schedule.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In at least one embodiment, a system facilitates employee scheduling. The system can comprise a processor, a machine-learning model, and a scheduling component. The processor can execute computer-implemented components stored in memory. The machine-learning model can be trained on employee workflow and scheduling data to determine and/or infer one or more employee risk factors (ERFs). ERFs can generally be parameters that can affect an employee schedule. The machine-learning model can recognize patterns associated with the ERFs. The scheduling component can schedule respective employees based on respective ERFs associated with those employees.

Another example embodiment is a method facilitating employee scheduling that is implemented by a system having a processor. The method can access, by the system, a machine-learning model trained on employee workflow data and scheduling data to determine, by the system, one or more employee risk factors (ERFs) that are parameters that can affect schedules. The machine-learning model can recognize patterns and other associations correlated between the ERFs and the employee workflow and scheduling data. For example, certain ERFs can correlate on which days of a week an employee is likely to work as scheduled, which days of a week an employee is likely to take time off from work, and which days of a week an employee is likely to take sick leave. The method can schedule, by the system, employees based in part on ERFs being associated with respective employees.

Another embodiment is a method implemented by a machine-readable storage medium, having executable instructions. The executable instructions, when executed by a processor, facilitate performance of operations, including accessing a machine-learning model trained on employee workflow data and scheduling data to determine one or more employee risk factors (ERFs) that can be parameters that affect an employee schedule. The machine-learning model can recognize patterns associated with the ERFs. The method schedules employees based in part on the ERFs.

To the accomplishment of the foregoing and related ends, the disclosed subject matter comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, system for scheduling objects that can be employees in accordance with one or more embodiments described herein;

FIGS. 2A-D illustrate example, non-limiting, graphic images used by a system for scheduling objects in accordance with one or more embodiments described herein;

FIG. 3 illustrates another example, non-limiting, system for scheduling objects in accordance with one or more embodiments described herein;

FIG. 4 illustrates an example, non-limiting, method for scheduling objects based in part on risk factors in accordance with one or more embodiments described herein;

FIG. 5 illustrates an example, non-limiting, method for scheduling objects based in part on risk factors in accordance with one or more embodiments described herein;

FIG. 6 illustrates an example, non-limiting, method for scheduling objects based in part on risk factors in accordance with one or more embodiments described herein;

FIG. 7 illustrates an example, non-limiting, method for scheduling objects based in part on risk factors in accordance with one or more embodiments described herein;

FIG. 8 illustrates an example, non-limiting, system for training a machine-learning model in accordance with one or more embodiments described herein;

FIGS. 9-11 illustrate example, non-limiting, system(s) for automatically determining asset performance in accordance with one or more embodiments described herein;

FIG. 12 illustrates an example, non-limiting, computing environment in which one or more embodiments described herein can be facilitated; and

FIG. 13 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

As also mentioned below, the various embodiments described herein can be implemented with hardware logic, software, or a combination of both that can in turn implement the various embodiments as systems, apparatus, components, apparatus, and methods or any other type/kind of implementation with a combination of these approaches and without limitation to the various embodiments described herein. References can be made herein to a hospital or medical environment without limitation to the various embodiments or claims scope. References to hospitals, medical facilities, or medical environments is provided for example purposes only and the embodiments described herein can be useful in some aspect toward any suitable type of schedule, scheduling action, related activity, related product, related system, production and other types of scheduling, and the like, without limitation, and other similar environments and uses.

Often, in the healthcare environment, when scheduling issues remain unresolved, those scheduling issues can accumulate and/or fester creating larger issues that healthcare facilities may desire to rapidly address. For example, in some hospitals, labor can account for over 50% of the total operating venue. While labor is necessary, a large percentage of that cost may be attributed to employee turnover. Past studies have indicated turnover rates in some medical facilities spanning from 14% to 19% per year. According to those studies, the average cost of turnover for a bedside RN is equivalent to about a half-year salary of an RN and if there is significant employee turnover, a hospital can lose millions of dollars per year. By determining scheduling patterns, assessing associated risks, and providing employees the opportunity to influence their respective schedules, it is conceivable that the various embodiments of the invention described herein can increase employee satisfaction, ultimately decreasing employee turnover and can create a personalized, low-risk schedule for both employers and employees.

One example embodiment of the invention can contain a grid of automated employee schedule population. Rather than referencing pre-defined employee preferences when placing (populating) employee names on the grid to produce a schedule, these 2-dimensional grids representing schedules are populated based on factors referred to as the Employee Risk Factors (ERFs). The concept of ERFs is introduced now and further described in detail below. Some embodiments can use machine-learning models to recognize and produce one or more ERFs assigned to one or more employees that are to be scheduled. For example, machine learning can produce initial ERFs by recognizing patterns in which days of the week an employee is likely to work to discover a “Monday work ERF”, a “Tuesday work ERF”, a “Wednesday work ERF”, a “Thursday work ERF”, a “Friday work ERF”, a “Saturday work ERF”, and a “Sunday work ERF”. Some or all these seven ERFs can be assigned to one or more employees or all seven ERFs can be assigned to each employee. Machine learning can recognize/discover other ERFs such as when employees are likely to take time off or sick leave (“time off ERF” and “sick leave ERF”) and additionally discover discrepancies between scheduled hours and worked hours (“hour discrepancy ERF”). Each of these items can be expressed as a probability in various types of ERFs assigned to various employees.

By way of another example, if a nurse has frequently worked Wednesdays, has not taken time off on Wednesdays or specifically July 26, and shows unnoticeable variation in shift arrival time, then that nurse would have a low corresponding ERF value for Wednesday, July 26. The employees with the lowest ERF(s) for each schedule time can be prioritized for assignment to those periods of low respective ERF. If a best match has not been found, a scheduler can be provided, in some embodiments, with a set of available employees sorted by corresponding ERFs of interest.

As the grid accumulates employee schedules, various embodiments can assess overtime ERFs and Burnout risk ERFs possibly by using an employee's current scheduled hours and previous overtime patterns. An employee can be considered an overtime risk if he/she is scheduled for maximum work hours and is likely to work overtime for one or more of scheduled shifts. An employee can be considered a burnout risk if the employee has consistently worked overtime for a specified time period. These assessments can be displayed to the supervisor, allowing the supervisor to accept or mitigate the risks. Once a supervisor has accepted the schedule, a notification could be sent to respective employees to approve their shifts. If an employee declines the schedule, he/she can provide in various embodiments feedback to assure greater accuracy in future scheduling and processing. When shifts have been accepted by various scheduled employees, the accepted schedule may be broadcast via email or in other ways to those of interest and the schedule can be committed for execution and completion.

In other example embodiments, data and ERFs useful for producing an employee schedule can be selected and calculated by leveraging a machine-learning algorithm and a predictive model. For example, an embodiment can develop an understanding, by using ERFs and other data associated with that employee. For example, an employee's work history can be used to predict, for both the supervisor and the employee, desired scheduling patterns. The use of ERFs with an initial pattern/risk factor assessment can provide a reliable schedule for the supervisor. Assessing time-off/sick leave request ERFs provides assurance that the employees scheduled are likely available. Comparing the actual start time of the shift with the scheduled time can identify late arrival patterns that could prevent full coverage of a shift.

While some of these parameters encoded as ERFs can appear more advantageous for the supervisor, there could be legitimate reasons why some employees can have new late arrival/time-off patterns. For example, their current schedule could have conflicts with personal obligations, so by analyzing these patterns, an employee can achieve a more flexible, personalized schedule, which creates a win-win situation for the manager and employee. Additionally, the notification for schedule acceptance can provide a meaningful interaction with the employee, allowing him/her to feel more in control of respective work hours. Depending on availability, the employee may have no choice but to work a declined shift. Regardless of outcome, an employee that declines an initial request can be provided an opportunity to submit feedback on why a particular shift is not a good fit. If there is not a single instance of unavailability, the employee's feedback to associated ERFs and be weighted more heavily than in previous history so that new, more accurate trends of employee behavior related to scheduling can develop. The overtime feature can facilitate predicting such occurrences early to mitigate incurring unnecessary costs. By separating burnout risks and overtime risks, a supervisor can be notified of severity or particularly ERFs. Consistently accumulating even minimal overtime on a larger population can have a significant financial cost, while employees with potential burnout risks can be unable to properly care for patients.

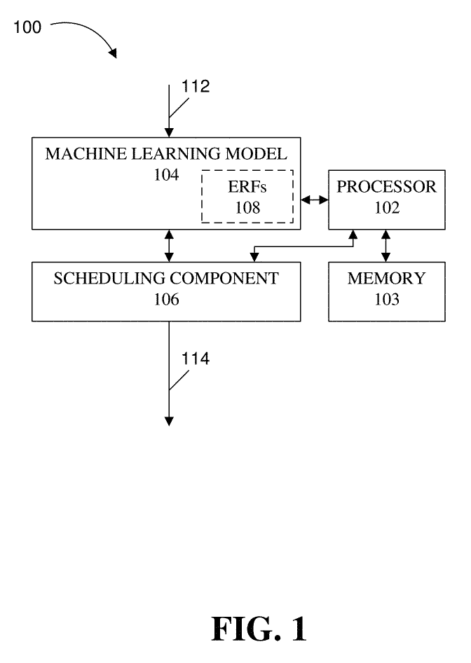

FIG. 1 illustrates an example, non-limiting, system 100 that facilitates scheduling objects. The system 100 can schedule objects (e.g., individuals, hardware, software, equipment, groups, etc.) having different risk factors that can affect schedule of respective objects in accordance with one or more embodiments described herein. The examples described herein sometimes make reference to scheduling employees for a work schedule, but other objects (items) such as different components with different tolerances (e.g., tolerance risk factors) can be scheduled for production a machine including those different components to maximize overall tolerance of the finished machine. In another example, life span probabilities (risk factors) of each of many different parts can be scheduled to produce a machine with those parts having a desired lifespan based in part on “lifespan risk factors” of those parts. Other risk factors sharing other common traits can be used in other embodiments when scheduling various events using those risk factors to minimize one or more characteristics represented by those risk factors.

The system 100 can include a processor 102 that executes computer-implemented components stored in memory 103, a machine-learning model 104, and a scheduling component 106. The machine-learning model 104 can be trained on employee workflow and scheduling data to determine or infer one or more employee risk factors (ERFs) 108 that can be parameters affecting an employee schedule. The machine-learning model 104 can recognize patterns associated with the one or more ERFs. The scheduling component 106 schedules the respective employees based in part on the ERFs 108 associated with the respective employees to produce an employee work schedule, for example, having one or more desired characteristics as explained further below. Some embodiments of the system 100 can contain an optional input link 112 and an optional output link 114. The optional input link 112 can be hard wired or wirelessly connected to commutate input signals with the machine-learning model 104. The optional output link 114 can be hard wired or wirelessly connected to commutate output signals with the scheduling component 106 that can include data of a new employee schedule.

The system 100 of FIG. 1 may have some components or items implemented in hardware/logic, software, and/or a combination of hardware logic and software. In some configurations, the machine-learning model 104 can be implemented to understand/recognize patterns to predict employee-staffing outcomes when creating a new work schedule. Machine learning, within the machine-learning model 104, can be useful and create value in a variety of ways. For example, the machine-learning model 104 can create value in creating a personalized experience that can be implemented with software through a software user interface (UI) that provides ease of use to personnel creating a work schedule and employees accessing the schedule and approving their individual schedules. In some versions of various embodiments of the system 100, an addition of employee feedback can enhance a personal experience for the employee, while the employee risk factors (ERFs) assist in creating the optimal schedule for the manager. These positive experiences can facilitate solving the challenge of labor costs and turnover by providing employees some voice in the scheduling process.

In other embodiments, the machine-learning model 104 can implement a “boosting decision tree” algorithm or another algorithm with a desired performance. In alternative embodiments, the machine-learning model 104 can be trained with supervised machine learning and/or in other appropriate ways similar to how neural networks can be trained. The machine-learning model 104 can, at times, be enhanced with a risk factor/nearest neighbor algorithm that can provide an enhanced list of optional employees to the scheduling component 106 for use when the scheduling component 106 encounters schedule times lacking other employees with acceptable ERFs. This set of employees can consist of employees that have not met their approved hours that could work this shift, but those employees may be ranked by their ERFs and/or ordered using the nearest neighbor model. This can identify to the scheduling component 106 similarities between the employees in the list and employees that have already been selected for scheduling. In other embodiments, this list of employees can be sent from the machine-learning model 104 to the supervisor for possible manual scheduling into any remaining open scheduled times that can also have been flagged as incomplete schedule times in the new schedule by the machine-learning model 104 or the scheduling component 106.

The embodiments of devices, including the machine-learning model 104 described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect) described herein, one or more components can examine an entirety or a subset of data to which it is granted access and can provide for reasoning about or determine states of a system, environment, etc. from a set of observations as captured via events and/or data. Determinations can be employed to identify a specific context or action, and/or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

Employee risk factors (ERFs) can include a variety of employee specific parameters or tendency indicators that can have an impact on the schedule and/or how effective the schedule is executed. For example, some employee ERFs, and include in which days of a week a particular employee is likely to work as scheduled (as discussed earlier), in which days of a week the employee is likely to take time off from work, in which days of a week the employee is likely to take sick leave, and the like.

A wide variety of other employee risk factors can be generated and used in employee work scheduling or in other situations. Alternatively, a complete “master list” of ERFs can be continuously maintained and updated when new data is available. However, only different subsets of this master list of ERFs can be used when the system 100 creates a schedule. As another example, consider that an employee can be likely scheduled for a certain set of days and it can be desired to know the variance between their previous worked days and scheduled new days by comparing these new days with the older schedule. In this example, the machine-learning model 104 can determine that a nurse is scheduled every Wednesday, but is always late by 30 minutes or greater. This information can be encapsulated with a “late Wednesdays Y ERF” (Y ERF). Another example can represent the “specific days Z ERF” (Z ERF) that corresponds to the same specific days of the week that the scheduling component 106 desires to place in the new employee work schedule. A third ERF can indicate an education or other qualifications of the employee. For example, a “certificates X ERF”, (X ERF) can indicate how many certificates a nurse employee holds.

Thus, based on this “late Wednesdays Y ERF”, “specific days Z EVER”, and certificates X ERF″, the machine-learning model 104 can appropriately combine two or more ERFs before the ERFs may be passed to the scheduling component 106. ERFs passed to the scheduling component 106 may be based in part on probabilities, P( ). In another example, employee ERFs can be combined together by a summation of two or more different ERFs represented as probabilities with each of the summed ERF probability values being scaled by a real constant:

combined risk factor=P(X)+P(Y)+3P(Z) Equation (1)

Notice that this risk combined risk factor could either be considered as a negative factor. For example, an employee could have a high-risk factor that would make him/her less fit for the shift. This could also be a positive ‘Best Fit’ factor, which would take a more positive light for determining the shift.

As previously mentioned, the machine-learning model 104 can identify a noticeable discrepancy between employee scheduled hours and actual hours worked by an employee. When this occurs, the machine-learning model 104 in coordination with the scheduling component 106 can update the grid and display the newest pay period with schedules that are generated through a schedule creation process. This schedule creation process can use a supervised machine-learning algorithm and ERF values associated with the discrepancy between the employee's scheduled hours and the actual hours worked. The machine-learning model 104 can then make appropriate changes of corresponding ERFs, as understood by those with ordinary skill in the art.

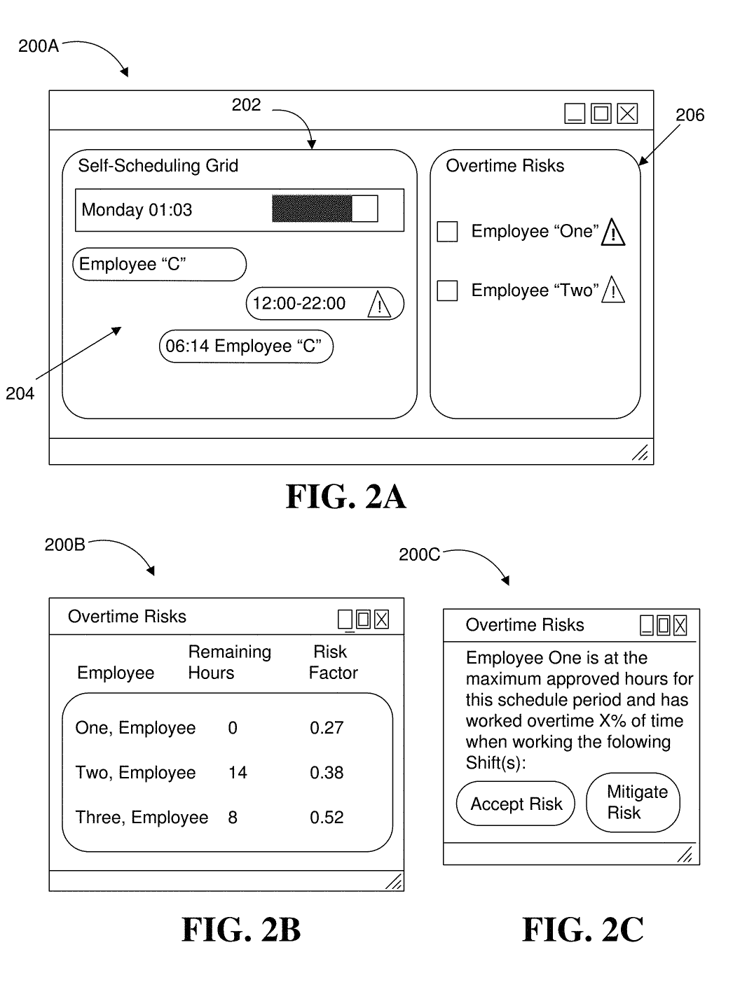

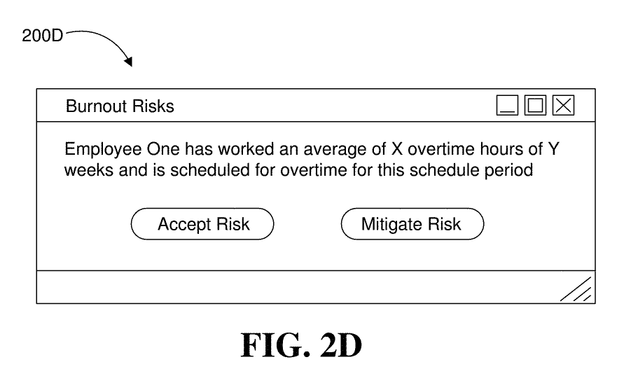

FIGS. 2A-2D illustrate non-limiting examples of window graphics 200A-D that can be displayed by the system 100 on a graphical user interface (GUI) or another display. These window graphics 200A-D can allow supervisors and, optionally, employees to access the functionality of the system 100 through some of the example window graphics 200A-D illustrated in the figures and any number of countless other non-illustrated window graphics, graphical user interfaces, or even different human/machine interfaces.

In alternative embodiments, the scheduling component 106 can create a schedule grid 202, as illustrated in FIG. 2A. This example 2-dimensional grid can have slots 204 in rows automatically scheduled (populated) by the scheduling component 106 (FIG. 1) and then have remaining open slots/times scheduled by a manager using one or more GUIs. The system 100 can have additional features implemented, in part, by different GUIs that inform supervisors the probability an employee will actually work overtime in the created schedule based, in part on a history of that employee's history of work schedule performance. Some configurations can also highlight employees that have worked overtime more frequently for a sufficient length of time. For example, this can be accomplished in the window graphics 200A of FIG. 2A in another portion 206 of the window graphics 200A. The supervisor can be informed by the system 100 running software within the processor 102 to generate image data and other data to for display on a graphical user interface (GUI) conveying the overtime (or other) risks in an appropriate way to the supervisor(s). Of course, in various embodiments, software can be running in both the processor 102 and the scheduling component 106, only in the scheduling module, and/or in other place(s).

In various other embodiments, the machine-learning model 104 can assess overtime data and burnout risk data that are associated with a respective employee and can create burnout related ERFs associated with that employee and provided those ERFs to the scheduling component 106. These ERFs can be additionally used by the scheduling component 106 when creating future schedules. These can also be additionally displayed in GUIs similar to the graphics window 200B and the graphics window 200C (FIGS. 2B-C). In these example figures, graphics window 200B displays potential/optimum employees to schedule for an overtime slot together with the maximum hours left, including overtime, as well as their overtime ERF. Graphics window 200C displays a warning of a potentially risky overtime candidate that will exceed their maximum hours in a new schedule and provides a way for a supervisor to override or prevent that employee from being considered for current scheduling. Graphics window 200D displays a warning of a potentially risky burnout candidate that has consistently worked significant overtime in recent past schedules. Thus, graphics window 200D warns about a burnout candidate in the current schedule and provides an opportunity for a supervisor or another appropriate person to override scheduling that candidate from additional overtime in the current schedule.

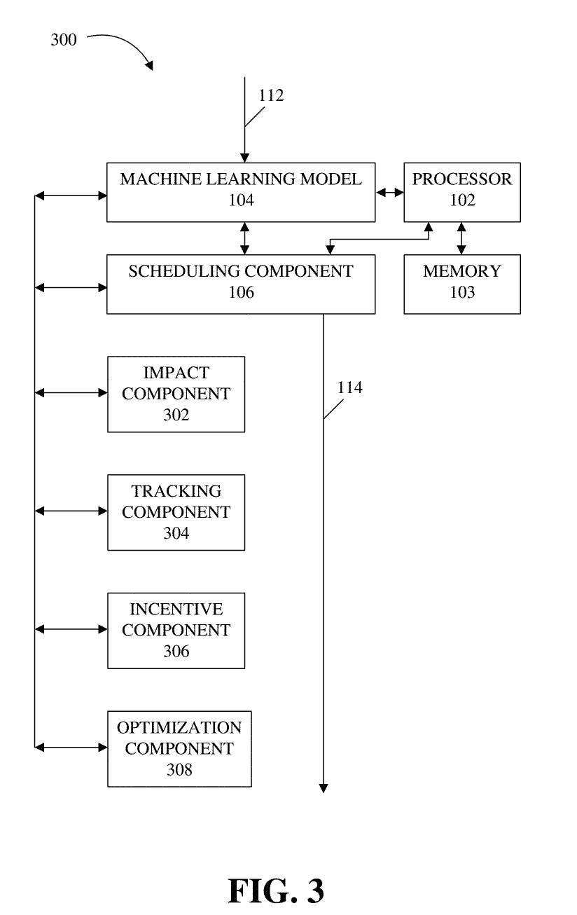

FIG. 3 illustrates an example, non-limiting, system 300 for scheduling items, such as employees, in accordance with one or more embodiments described herein. Repetitive description of like elements employed in other embodiments described herein is omitted for sake of brevity. The system 300 can comprise one or more of the components and/or the functionality of the system 100, and vice-versa. The system 300 can include similar/same portions of system 100 such as a processor 102 that executes computer-implemented components stored in memory 103, a machine-learning model 104, and a scheduling component 106, optional input link 112, and the optional output link 114. The system 300 additionally includes an impact component 302, a tracking component 304, an incentive component 306, and an optimization component 308. As illustrated, the machine-learning model 104, the scheduling component 106, the impact component 302, the tracking component 304, the incentive component 306, and the optimization component 308 may share a common bus allowing each of these components to communicate with each other bidirectionally.

In various embodiments, the impact component 302 can employ the machine-learning model 104 to determine an impact certain ERFs associated with respective employees have on workflow operations. Workflow operations is a broad concept that can include operations that produce a tangible or intangible (intellectual property) product or service and other products and the like. For example, an overtime ERF and a burnout ERF can affect workflow operations negatively. Having one or more employees with high values of these risk factors can lead to poor quality products or services because those employees can be sleepy and lack detailed attention in performing their part of a workflow process.

Alternative environments can have a tracking component 304 that may track, in real-time, inputs of schedule data and actual work data associated with one or more employees. The tracking component 304 can send information based in part on the real-time schedule data and actual work data to the scheduling component 106 so that a real-time schedule can be updated with real-time information. The tracking component 304 can also send appropriate real-time data to the machine-learning model 104 for more rapid learning before a schedule is completely executed to allow related schedules to be generated more rapidly and possibly with higher quality that employees may implement well.

In other example embodiments, when an organization is under staffed or is overwhelmed by unexpected demands, the incentive component 306 may provide current employees optional incentives via the scheduling component 106 and various GUIs as discussed above. For example, incentives can include overtime pay, extra vacation time or days, and the like as understood by those of ordinary sill in the art. The scheduling component 106 can then schedule employees based in part on the employee incentives selected by agreeable employees. For example, when a new schedule is presented to an employee, the employee may be prompted to work extra overtime or to contribute more than the standard number of ours by accepting an incentive. For example, the employee may be asked to work more evening hours as shown in a tentative schedule and provided a chance to gain a half day of extra vacation for working those hours. In other embodiments, the employee may be prompted to choose one of two or more incentives when agreeing to additional overtime.

In other example embodiments, an optimization component 308 may generate inference ERFs. The machine-learning model may select inference ERFs that can influence such characteristics as potential points of failure, weakness of parts and structures, bottlenecks in operations, and the like. The optimization component 308 can direct the scheduling component 106 to generate schedules based at least on some of the inference ERFs. For example, if a power grid has assets that are prone to failure, then the machine-learning model may tend to schedule more personnel to attend to the assets that may fail relatively soon. For example, if a large voltage sub-station is having transformer and other issues, additional personnel with the ability to repair substations may be scheduled near that and other sub-stations than are normally scheduled.

Methods that can be implemented in accordance with the disclosed subject matter will be better appreciated with reference to the following flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

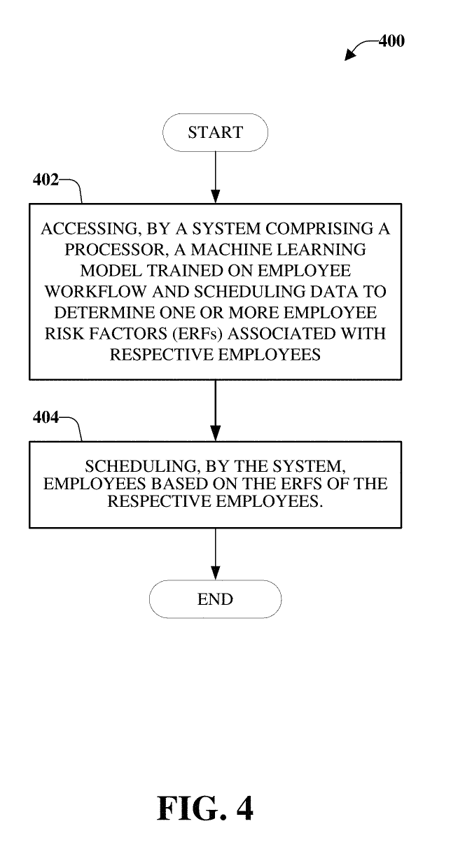

FIG. 4 illustrates an example, non-limiting, embodiment of a method 400 for scheduling objects based in part on risk factors of the objects in accordance with one or more embodiments described herein. Repetitive description of like elements employed in other embodiments described herein is omitted for sake of brevity. The objects can be employees and the schedule can be a work schedule. At 402, a system comprising a processor, can access a machine-learning model trained on employee workflow and scheduling data to determine one or more employee risk factors (ERFs) associated with respective employees. Employees can be scheduled, by the system, at 404, based on the ERFs associated with respective employees. The determining ERFs associated with respective employees and the scheduling based on the ERFs, can be performed as described earlier.

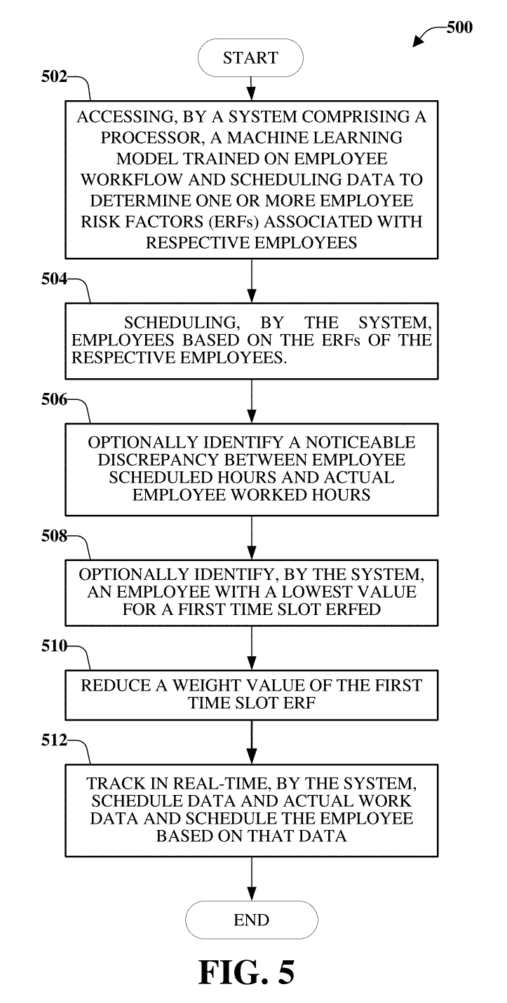

FIG. 5 illustrates another example, non-limiting, embodiment of a method 500 of scheduling employees based in part on risk factors of a work schedule of the employees. Repetitive description of like elements employed in other embodiments described herein is omitted for sake of brevity. Similar to the previous method 500, a system comprising a processor, can access a machine-learning model trained on employee workflow and scheduling data can determine ERFs, at 502, and can schedule employees, at 504. In other embodiments, the method 500 can optionally identify a noticeable discrepancy, at 506, between employee scheduled hours and actual employee worked hours.

In yet other embodiments, the method 500 can optionally identify, by the system, an employee with a lowest value for a first time slot ERF, at 508. The first time slot ERF indicates that this employee should preferably be scheduled in a time slot of the first row of a schedule grid. A weight value of the first time slot ERF is reduced, at 510, due to their good history of working in the first time slot.

In some embodiments, a particular employee can be scheduled based in part on an overtime ERF associated with previous overtime patterns associated the particular employee. Additionally, the method 500 can track in real-time, by the system, schedule data and actual work data, at 512, associated with a particular employee and can be scheduled based on the schedule data and actual work data.

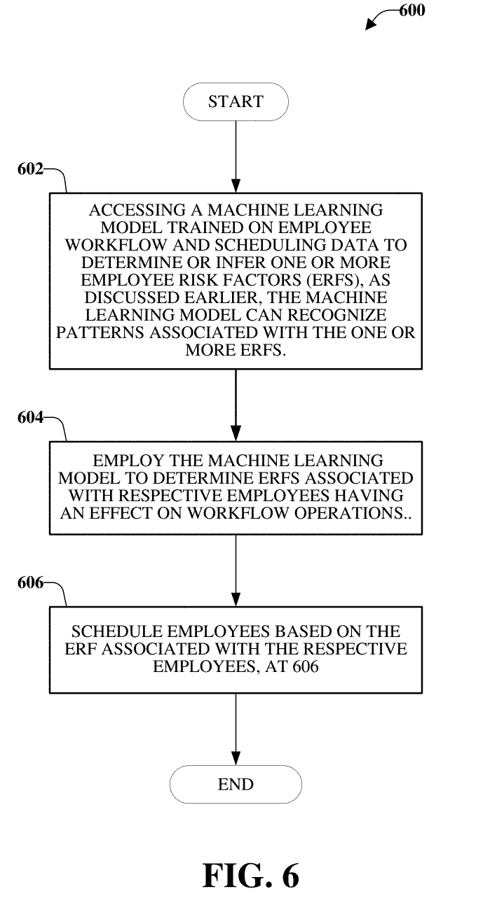

FIG. 6 illustrates an example, non-limiting, method 600 for scheduling objects, items, events, employees, and the like in accordance with one or more embodiments described herein. Repetitive description of like elements employed in other embodiments described herein is omitted for sake of brevity. At 602, a system comprising a processor, can access a machine-learning model trained on employee workflow and schedule data to determine or infer one or more employee risk factors (ERFs). As discussed earlier, the machine-learning model can recognize patterns associated with the one or more ERFs. At 604, the system can employ the machine-learning model to determine ERFs associated with respective employees that have an effect on workflow operations. The method 600 can schedule employees based on the ERF associated with the respective employees, at 606.

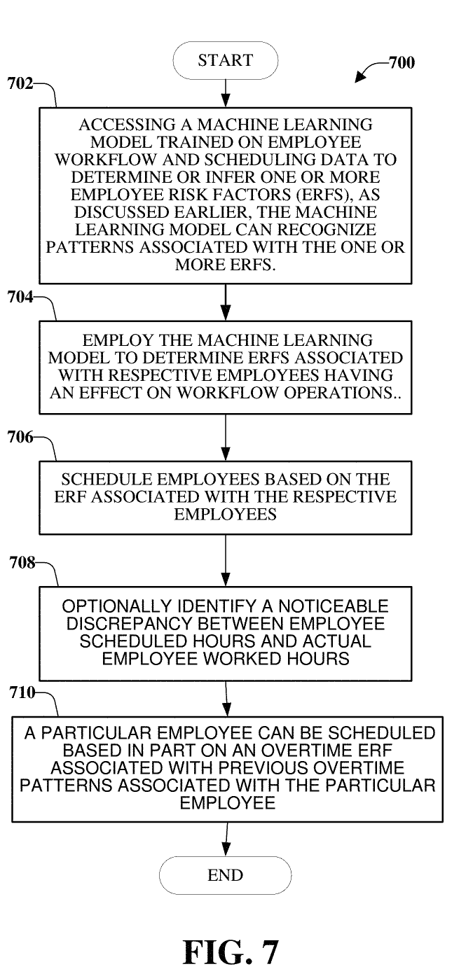

FIG. 7 illustrates another, non-limiting, method 700 for scheduling objects, items, events, employees, and the like in accordance with one or more embodiments described herein. Repetitive description of like elements employed in other embodiments described herein is omitted for sake of brevity. At 702, a system comprising a processor, can accessing a machine-learning model trained on employee workflow and scheduling data to determine or infer one or more employee risk factors (ERFs). At 704, the system can employ the machine-learning model to determine ERFs associated with respective employees that have an effect on workflow operations. The method 700 can schedule employees based on the ERF associated with the respective employees, at 706. The method 700 can optionally identify, at 708, a noticeable discrepancy between employee scheduled hours and actual employee worked hours. In some other configurations, a particular employee can be scheduled, at 710, based in part on an overtime ERF associated with previous overtime patterns.

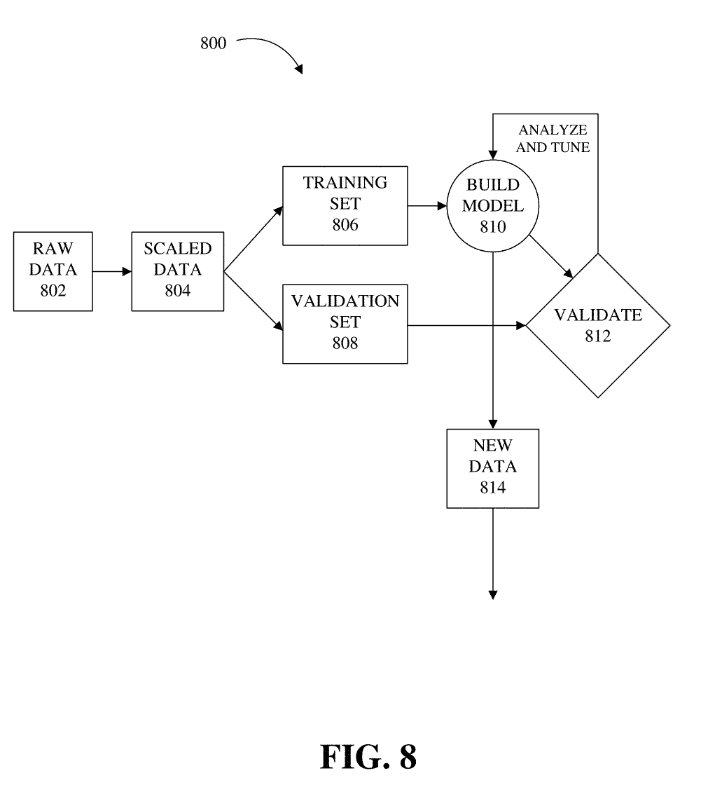

FIG. 8 illustrates an example, non-limiting, system 800 for training a machine-learning model on known data/inputs so that the system 100 can later accurately categorize unknown data/input accordance with one or more embodiments described herein. Repetitive description of like elements employed in other embodiments described herein is omitted for sake of brevity.

The example system 800 of FIG. 8 includes a raw data unit 802, a scaled data unit 804 that may scale data from the raw data unit 802. Once scaled, the scaled data unit 804 may send this data a training set unit 806 and a validation set unit 808 so that both if these units receive the scaled data. The validation set unit 808 may create a set of data that is sent to a validation unit 812 and used to validate new build model created by the new model unit 810. Results from the validation unit 812 can also be sent to the new model unit 810 so that the current feedback from the validation unit 812 can be used when generating the next, new model. Once the new model is completed, it is output on the output line from the new model unit 810 so that it can be used in future calculations. In other embodiments, different organization of units and other components in FIG. 8 can be desirable and that other components, logic and/or software may be used and/or removed from the system 800 as desired.

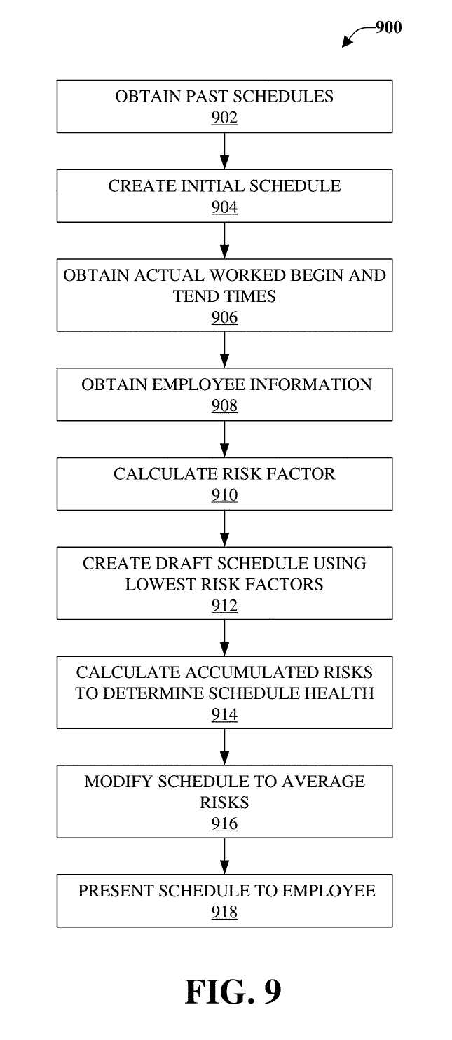

FIGS. 9-11 illustrate other non-limiting methods, systems, components, and the like that may be helpful when scheduling objects into a schedule as at least discussed in the embodiments herein. Other alternative methods and actions may be used to accomplish producing schedules for a variety of objects. FIGS. 9-11 illustrate other method acts that may be implemented by a system, a computer, a computer executing instructions from a memory, and the like, or in a combination of different and/or other implementations.

FIG. 9 illustrates an example method 900 that may be used to schedule one or more employees with the method 900 implemented as a computer-implemented method, a computer programmed method, or another desired type of method. Repetitive description of like elements employed in other embodiments described herein is omitted for sake of brevity. The method 900 may begin by obtaining past schedules, at 902. These schedules may be used as a starting point in creating and filling out a grid for creating, at 904, a new initial schedule that can uses the same employees scheduled for similar days/hours as the previous schedules. At 906, the actual worked begin and end times are obtained to determine if the previous schedule was executed as scheduled or if changes shall be implemented in the new schedule. Employee information may be obtained, at 908, so that employee availability may be determined. Employee risk factors may be calculated and updated, at 910, so that the risk factors may be used to improve the new schedule. A new draft schedule may be created, at 912, or revised based on the lowest values of the employee risk factors. An overall risk value of the risk factors of the new schedule is calculated, at 914, to determine an overall health of the new schedule. The lower the overall risk value of a sum of the risk factors of the new schedule, the more optimal and the lower a risk of the new schedule not being executed as schedule. If necessary, the schedule may be adjusted, at 916, to modify the new schedule to lower the overall risk value. The new schedule may be presented, at 918, to employees for approval.

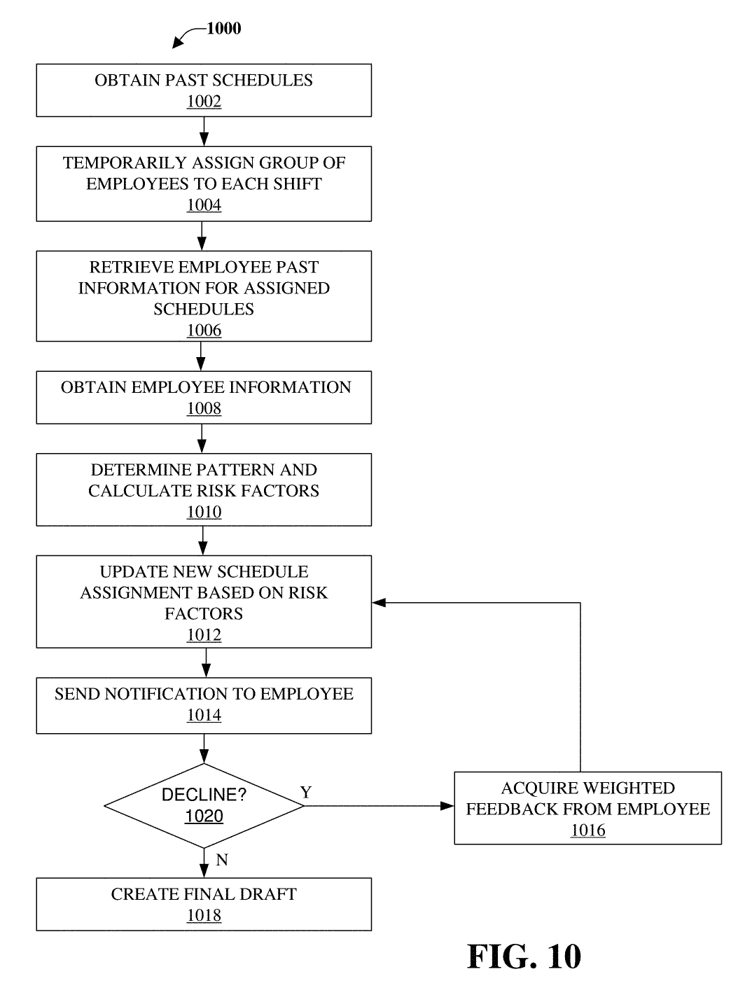

FIG. 10 illustrates an example method 1000 that may be us to schedule one or more employees and the method 1000 may be an embodiment implemented as a computer-implemented method, a computer programmed method, or another desired type of method. Repetitive description of like elements employed in other embodiments described herein is omitted for sake of brevity. The method 1000 may begin by obtaining, at 1002, past schedules. These schedules may be used as a starting point when temporarily assigning groups of employees to each shift, at 1004. Employee past information for assigned schedules may be retrieved, at 1006. Employee information may be obtained, at 1008, and may include the employee's desired schedule days, desired work times, and other personal scheduling information for each employee, as needed. Patterns of employee(s) behavior to past actual schedules may be determined, at 1010, and associated risk factors may be calculated. The new schedule may then be updated, at 1010, based in part, on the previously calculated risk factors. Assignments of employees to the new schedule may be updated based on the prier determined risk factors and the updated schedule may be sent to employees contained in the schedule, at 1014. A determination is made, at 10, to determine of the employee(s) have accepted their schedule. If not, then weighted feedback may be collected from the employee(s), at 1016, and the method 1000 may repeatedly create a new schedule based in part, on the risk factors as modified by the weight factors provided by the employee(s). Assignments of employees to the new schedule may be updated based on the prier-determined risk factors and the updated schedule may be sent to employees contained in the schedule, at 1014. A determination is again made, at 1020, to determine of the employee(s) have accepted their schedule. If employee(s) have accepted the schedule, then a final draft of schedule may be created, at 1018, and further processed as the next working schedule.

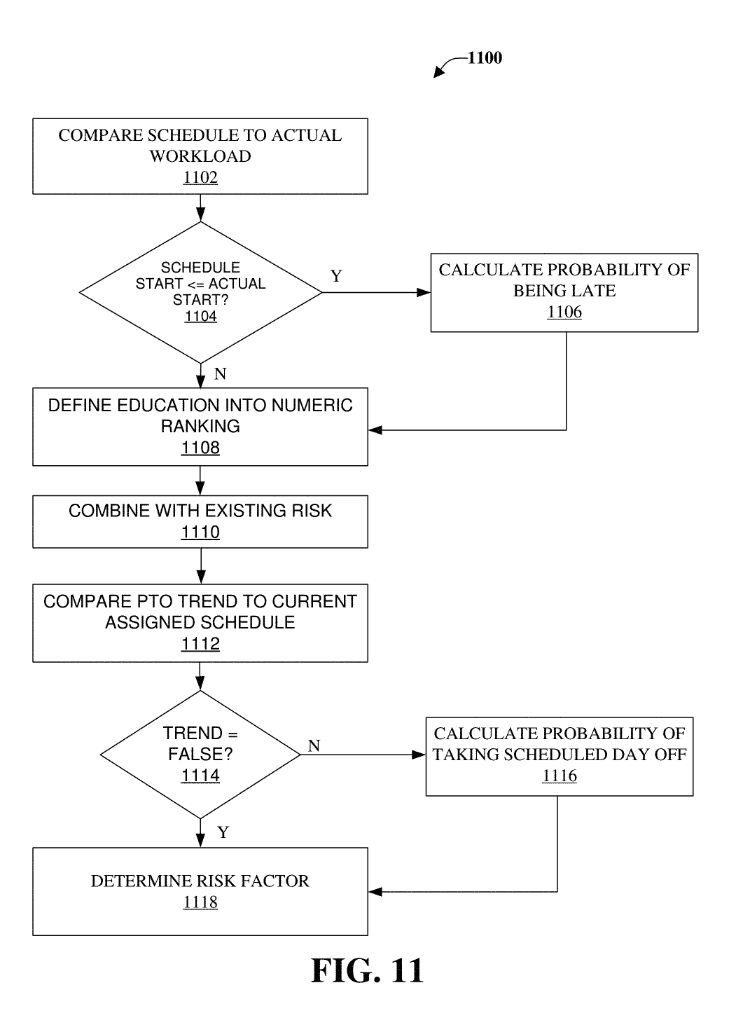

FIG. 11 illustrates an example method 1100 that may be us to schedule one or more employees and the method 1100 may be an embodiment implemented as a computer-implemented method, a computer programmed method, or another desired type of method. Repetitive description of like elements employed in other embodiments described herein is omitted for sake of brevity. The method 1100 may begin by obtaining, at 1102, past schedules. The method 1100 may begin by comparing a prior schedule to an actual workload, which may indicate if the schedule provided adequate personnel for the previous workload encountered over the scheduling period. Employee start times may be compared to actual start times to determine, at 1104, which employees were late to a schedule work period. For the late employees, a probability calculation may be performed, at 1106, that provides a probability that a specific employee may be late. Method flow may continue to block 1108 where education associated with employees may be converted and defined with a numeric ranking or another type of parameter. Education may include work related certificates, education degrees and other accomplishments. The education ranking may be combined, at 1110, with other employee related risks that may influence a work schedule. A comparison may be made to compare paid time off (PTO) of respective employees, at 1112, to determine, at 1114, if there is a trend of PTO to a currently assigned schedule. If there is a trend of noticeable PTO, then a calculation of a probability of taking PTO may be scheduled, at 1116. This may be part of an ERF and may be calculated as a probability of a day, week, or another time period. Next, the method 1100 may calculate a combined probability risk factor that may be a sum of ERFs for a single employee and combined with other parameters as discussed above when generating a new schedule.

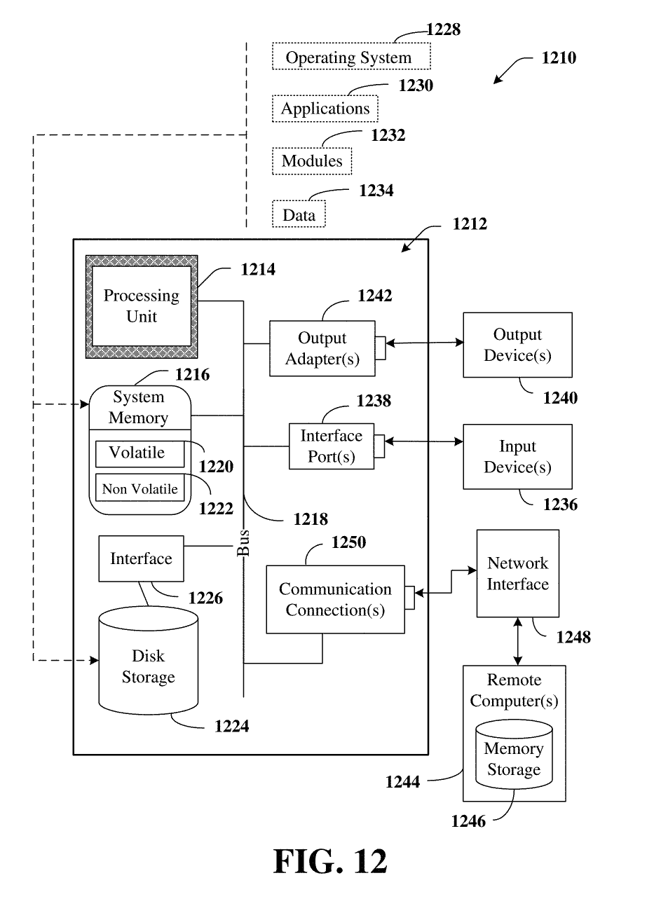

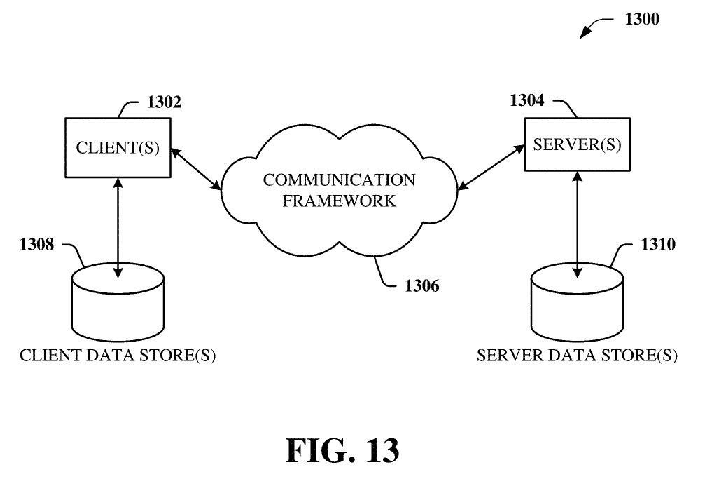

In order to provide a context for the various aspects of the disclosed subject matter, FIGS. 12 and 13 as well as the following discussion are intended to provide a brief, general description of a suitable environment in which the various aspects of the disclosed subject matter can be implemented.

With reference to FIG. 12, an example environment 1210 for implementing various aspects of the aforementioned subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Multi-core microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable PROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. The disk storage 1224 includes, but is not limited to, devices like a magnetic disk drive, floppy disk drive, tape drive, Jaz drive, Zip drive, LS-100 drive, flash memory card, or memory stick. In addition, the disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1224 to the system bus 1218, a removable or non-removable interface is typically used such as interface 1226.

It is to be appreciated that FIG. 12 describes software that acts as an intermediary between users and the basic computer resources described in environment 1210. Such software includes an operating system 1228. Operating system 1228, which can be stored on disk storage 1224, acts to control and allocate resources of the computer 1212. System applications 1230 take advantage of the management of resources by operating the operating system 1228 through program modules 1232 and program data 1234 stored either in system memory 1216 or on disk storage 1224. It is to be appreciated that one or more embodiments of the subject disclosure can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port can be used to provide input to computer 1212, and to output information from computer 1212 to an output device 1240. Output adapters 1242 are provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network nodes and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the system bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample computing environment 1300 with which the disclosed subject matter can interact. The sample computing environment 1300 includes one or more client(s) 1302. The client(s) 1302 can be hardware and/or software (e.g., threads, processes, computing devices). The sample computing environment 1300 also includes one or more server(s) 1304. The server(s) 1304 can also be hardware and/or software (e.g., threads, processes, computing devices). The servers 1304 can house threads to perform transformations by employing one or more embodiments as described herein, for example. One possible communication between a client 1302 and servers 1304 can be in the form of a data packet adapted to be transmitted between two or more computer processes. The sample computing environment 1300 includes a communication framework 1306 that can be employed to facilitate communications between the client(s) 1302 and the server(s) 1304. The client(s) 1302 are operably connected to one or more client data store(s) 1308 that can be employed to store information local to the client(s) 1302. Similarly, the server(s) 1304 are operably connected to one or more server data store(s) 1310 that can be employed to store information local to the servers 1304.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system that facilitates scheduling employees, comprising:
a processor that executes computer implemented components stored in memory;
a machine-learning model trained on employee workflow and scheduling data to determine or infer one or more ERFs (employee risk factors) that are parameters affecting an employee schedule, wherein the machine-learning model can recognize patterns associated with the one or more ERFs; and
a scheduling component that schedules respective employees into the employee schedule based in part on ERFs associated with the respective employees.

2. The system of claim 1, wherein the one or more ERFs include one or more selected from the group consisting of: in which days of a week a particular employee works as scheduled, in which days of the week the employee takes time off from work, or in which days of the week the employee takes sick leave.

3. The system of claim 1, wherein the machine-learning model identifies a discrepancy between scheduled hours and actual hours worked by one employee, and updates one or more ERF values associated with the discrepancy.

4. The system of claim 1, wherein the scheduling component identifies a certain employee as completing a work schedule for a schedule time slot and reducing a value of a schedule time slot ERF of the certain employee.

5. The system of claim 1, further comprising:
a risk component that assesses overtime data and burnout risk data that are associated with a specific employee and using the burnout risk data and current scheduled hours data to create a corresponding overtime and burnout ERF associated with the specific employee.

6. The system of claim 1, further comprising:
a tracking component that tracks in real-time schedule data and actual work data associated with a specific employee, and wherein the scheduling component will schedule employees based in part on the schedule data and actual work data associated with the specific employee.

7. The system of claim 1, further comprising:
an incentive component that provides for employee incentives, and wherein the scheduling component will schedule employees based in part on the employee incentives.

8. The system of claim 1, wherein the machine-learning model employs one or more from the group consisting of: a recursive learning algorithm, a backward propagation algorithm, and a continuous learning algorithm.

9. The system of claim 1, wherein the machine-learning model learns impact ERF values of respective influencers and provides the impact ERF values to the scheduling component to revise a proposed employee scheduling as a function of impact ERFs values.

10. The system of claim 8, further comprising:
an optimization component that generates inference ERFs, based on the machine-learning model, and wherein the inference ERFs are selected from the group consisting of: potential points of failure, weakness, and bottlenecks in operations, wherein the optimization component provides the inference ERFs to the scheduling component, and wherein the scheduling component generates schedules based in part on the inference ERFs.

11. A method, comprising:
accessing, by a system comprising a processor, a machine-learning model trained on employee workflow and scheduling data to determine employee risk factors (ERFs) associated with respective employees; and
scheduling, by the system, the respective employees based on the employee risk factors of the respective employees.

12. The system of claim 11, further comprising:
identifying, by the system, a noticeable discrepancy between scheduled hours and actual worked hours.

13. The method of claim 11, further comprising:
identifying, by the system, a specific employee with a lowest value for a first time slot ERF for a schedule first time slot; and
lowering a weight value of the first time slot ERF that is associated with the specific employee.

14. The method of claim 11, further comprising:
scheduling, by the system, a particular employee based in part on an overtime ERF associated with previous overtime patterns associated with the particular employee.

15. The method of claim 11, further comprising:
tracking, by the system, in real-time schedule data and actual work data associated with a specific employee; and
scheduling the specific employee based in part on the schedule data and actual work data associated with the specific employee.

16. A machine-readable storage medium, comprising executable instructions that, when executed by a processor, facilitate performance of operations, comprising:
accessing a machine-learning model trained on employee workflow and (scheduling data to determine or infer one or more employee risk factors (ERFs), wherein the machine-learning model can recognize patterns associated with the one or more ERFs that include one or more selected from the group consisting of: in which days of a week the employee is likely to work as scheduled, in which days of the week the employee is likely to take time off from work, and in which days of the week the employee is likely to take sick leave;
employing the machine-learning model to determine impact ERFs associated with respective employees have on workflow operations; and
scheduling employees based on the respective impact ERFs.

17. The machine-readable storage medium of claim 16, further comprising:
identifying a noticeable discrepancy between scheduled hours and actual worked hours.

18. The machine-readable storage medium of claim 16, further comprising:
identifying a specific employee with a lowest value for a second time slot ERF for a second schedule time slot; and
lowering a weight value the second time slot ERF that is associated with the specific employee.

19. The machine-readable storage medium of claim 16, further comprising:
scheduling a specific employee based in part on an overtime ERF associated with previous overtime patterns associated with the specific employee.

20. The machine-readable storage medium of claim 16, further comprising:
specific tracking in real-time schedule data and actual work data associated with a specific employee, and schedules specific employee based in part on the schedule data and actual work data associated with the specific employee.
